(19) United States
(12) Patent Application Publication
(10) Pub. No.: US 2026/0238917 A1
(43) Pub. Date: Aug. 13, 2026

(54) SPEAKER SYSTEM AND ELECTRONIC DEVICE

(71) Applicant: AAC Microtech (Changzhou) Co., Ltd., Changzhou City (CN)

(72) Inventors: Yufen Chu, Changzhou (CN); Yao Hui, Changzhou (CN); Weimin Chen, Changzhou (CN); Ruyang Wang, Changzhou (CN)

(21) Appl. No.: 19/344,598

(22) Filed: Sep. 30, 2025

Related U.S. Application Data
(63) Continuation of application No. PCT/CN2025/076882, filed on Feb. 11, 2025.

(51) Int. Cl. H04R 1/28; H04R 9/02; H04R 9/06

(52) U.S. Cl. CPC H04R 1/2834; H04R 9/025; H04R 9/06

(57) ABSTRACT

A speaker system and electronic device are provided. The speaker system includes a first housing, a first accommodating cavity is arranged inside the first housing; a first active vibrating diaphragm, the first active vibrating diaphragm is arranged inside the first accommodating cavity; a second housing, a second accommodating cavity is arranged inside the second housing, and the second accommodating cavity is communicated with the first accommodating cavity to form a closed cavity; a first passive vibrating diaphragm, the first passive vibrating diaphragm is arranged on one side of the second housing and is driven by the first active vibrating diaphragm to vibrate. The present disclosure can reduce the displacement distance of the first passive vibrating diaphragm, weaken a low-frequency vibration sensation of the speaker system, and improve low-frequency performance of the speaker system.

### CROSS-REFERENCE TO RELATED APPLICATIONS

This application is a continuation of International Application No. PCT/CN2025/076882, filed on Feb. 11, 2025, the entire content of which is incorporated herein by reference.

### TECHNICAL FIELD

The present disclosure relates to the technical field of speakers, and in particular to, a speaker system and an electronic device.

### BACKGROUND

With the rapid development of communication technology, electronic products are upgraded and replaced at an increasingly fast pace. Usage time and usage frequency of users on electronic products significantly increase, and higher requirements are also put forward on music functions that can be implemented in the electronic products. Speakers, as low-frequency units, are also widely used in existing smart electronic products. There are many parameters for evaluating the sound quality of the speakers, such as a resonance frequency and a low-frequency sensitivity. A speaker mainly relies on vibrations of a vibrating diaphragm to drive air to vibrate and generate sounds. If the vibrating diaphragm has high rigidity, system rigidity of the speaker may increase. As a result, the speaker has a high resonant frequency and a poor low-frequency sensitivity.

Under the same sound pressure level requirement, a conventional speaker generates a larger vibration displacement at a low frequency than at a middle to high frequency. The larger displacement may lead to a problem of a strong low-frequency vibration sensation. Meanwhile, the low-frequency performance of a conventional passive radiation speaker is limited by the rigidity and mass of the speaker itself. A vibrating diaphragm with excessive mass may increase a vibration displacement generated by the vibrating diaphragm, exacerbate the low-frequency vibration sensation of the speaker, and reduce the user experience, while a vibrating diaphragm with low rigidity is difficult to process, has a low yield, and is not easily applied to engineering.

Therefore, it is necessary to provide a new speaker system to solve the above technical problems.

### SUMMARY

The present disclosure aims to provide a speaker system and an electronic device that can provide negative rigidity for a vibrating diaphragm and can also improving low-frequency performance of a speaker while weakening a low-frequency vibration sensation of the speaker.

In order to solve the technical problem, the present disclosure provides a speaker system, the speaker system includes a first housing, a first accommodating cavity is arranged inside the first housing; a first active vibrating diaphragm, the first active vibrating diaphragm is arranged inside the first accommodating cavity; a second housing, a second accommodating cavity is arranged inside the second housing, and the second accommodating cavity is communicated with the first accommodating cavity to form a closed cavity; a first passive vibrating diaphragm, the first passive vibrating diaphragm is arranged on one side of the second housing and is driven by the first active vibrating diaphragm to vibrate; and at least one second passive vibrating diaphragm, the second passive vibrating diaphragm is arranged on one side of the second housing facing away from the first passive vibrating diaphragm, and a vibration starting direction of the second passive vibrating diaphragm and a vibration starting direction of the first passive vibrating diaphragm are opposite; and/or, the second passive vibrating diaphragm and the first passive vibrating diaphragm are arranged on the same side of the second housing, and a vibration starting direction of the second passive vibrating diaphragm and a vibration starting direction of the first passive vibrating diaphragm are the same.

Preferably, further including a third housing communicated with the second housing, and a third accommodating cavity is arranged inside the third housing; the second passive vibrating diaphragm is arranged between the second housing and the third housing, to separate the second accommodating cavity from the third accommodating cavity; a central magnetic block is arranged on the second passive vibrating diaphragm; and magnetic components that interact with the central magnetic block are arranged inside the second accommodating cavity and the third accommodating cavity.

Preferably, the magnetic components include a first magnetic member arranged on an inner wall of the third accommodating cavity and a second magnetic member arranged on an inner wall of the second accommodating cavity; the central magnetic block is fixedly arranged on one side of the second passive vibrating diaphragm close to the third accommodating cavity; and magnetization directions of the first magnetic member, the second magnetic member, and the central magnetic block are the same, so that a resultant force exerted to the central magnetic block by the first magnetic member and the second magnetic member when the second passive vibrating diaphragm is in a non-vibrating state is zero.

Preferably, the second accommodating cavity is communicated with the first accommodating cavity through at least one extension pipeline to form the closed cavity.

Preferably, the first active vibrating diaphragm is arranged inside the first accommodating cavity to divide the first accommodating cavity into a first front cavity and a first rear cavity; and the first rear cavity is communicated with the second accommodating cavity to form the closed cavity.

Preferably, the first housing is provided with a first output port for communicating the first front cavity with the outside, and the speaker system radiates a sound to the outside of the first housing through the first output port.

Preferably, the first rear cavity is communicated with the second accommodating cavity through at least one extension pipeline to form the closed cavity.

Preferably, the vibration starting direction of the first passive vibrating diaphragm and a vibration starting direction of the first active vibrating diaphragm are the same.

Preferably, the first housing is further provided with a second active vibrating diaphragm; the second active vibrating diaphragm is arranged on one side of the first housing facing away from the first active vibrating diaphragm; and a vibration starting direction of the second active vibrating diaphragm and a vibration starting direction of the first active vibrating diaphragm are opposite.

Preferably, a quantity of the second passive vibrating diaphragm is configured to be at least two; one of the second passive vibrating diaphragms is arranged on the side of the second housing facing away from the first passive vibrating diaphragm, and the vibration starting direction of the second passive vibrating diaphragm and the vibration starting direction of the first passive vibrating diaphragm are opposite; the other second passive vibrating diaphragm is arranged on one side of the first housing facing away from the second active vibrating diaphragm and has the same vibration starting direction as the first passive vibrating diaphragm; and/or, the other second passive vibrating diaphragm and the first passive vibrating diaphragm are arranged on the same side of the second housing, and has the same vibration starting direction as the first passive vibrating diaphragm.

Preferably, when the other second passive vibrating diaphragm is arranged the side of the first housing facing away from the second active vibrating diaphragm, a gap for allowing the first active vibrating diaphragm to vibrate is provided between the second passive vibrating diaphragm and the first active vibrating diaphragm.

Based on the above speaker system, The present disclosure further provides an electronic device, the electronic device includes the loudspeaker system according to any one of the above items.

Beneficial effects of the present disclosure are as follows: In the present disclosure, the first accommodating cavity and the second accommodating cavity are communicated to form the closed cavity. When the first active vibrating diaphragm is driven by electricity to vibrate in the first direction relative to the first housing, an internal air pressure among the first accommodating cavity, the extension pipe, and the second accommodating cavity may be affected. Fluctuations of the internal air pressure may cause the first passive vibrating diaphragm to vibrate in the first direction relative to the second housing. By the arrangement of the central magnetic block and the magnetic components, a restoring force of the second passive vibrating diaphragm during vibration in the first direction is reduced, which makes the second passive vibrating diaphragm exhibit a characteristic of a negative-rigidity vibrating diaphragm, thereby balancing forces generated by the vibrations of the vibrating diaphragms in the speaker system. The vibration sensation of the speaker system is greatly reduced without increasing the masses of the passive vibrating diaphragms and without putting forward a requirement on the rigidities of the passive vibrating diaphragms. Low-frequency performance of a speaker can be improved while a low-frequency vibration sensation of the speaker is weakened, and a low-vibration bandwidth of the speaker system is effectively expanded.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a schematic structural diagram of a speaker system according to an embodiment of the present disclosure.

FIG. 2 is a first schematic structural diagram of a speaker system provided in the conventional technology.

FIG. 3 is an equivalent circuit diagram of the speaker system shown in FIG. 2.

FIG. 4 is a diagram of a first embodiment of a speaker system according to an embodiment of the present disclosure.

FIG. 5 is a diagram of a second embodiment of a speaker system according to an embodiment of the present disclosure.

FIG. 6 is an equivalent circuit diagram of the speaker system shown in FIG. 1.

FIG. 7 is a second schematic structural diagram of a speaker system provided in the conventional technology.

FIG. 8 is a diagram of a third embodiment of a speaker system according to an embodiment of the present disclosure.

FIG. 9 is a diagram of a fourth embodiment of a speaker system according to an embodiment of the present disclosure.

FIG. 10 is a schematic structural diagram of a third housing in a speaker system according to an embodiment of the present disclosure.

FIG. 11 is an equivalent circuit diagram of the speaker system shown in FIG. 8 or FIG. 9.

FIG. 12 is a comparison diagram of a sound pressure level curve of the speaker system shown in FIG. 8 and FIG. 9 and a sound pressure level curve of the speaker system shown in FIG. 7.

FIG. 13 is a comparison diagram of a curve of a resultant force on the speaker system shown in FIG. 8 and FIG. 9 and a curve of a resultant force on the speaker system shown in FIG. 7.

FIG. 14 is a comparison diagram of a sound pressure level curve of the speaker system shown in FIG. 10 and a sound pressure level curve of the speaker system shown in FIG. 7.

FIG. 15 is a comparison diagram of forces changing with frequencies of first active vibrating diaphragms and first passive vibrating diaphragms in the speaker system shown in FIG. 10 and the speaker system shown in FIG. 7.

### DESCRIPTIONS OF REFERENCE NUMERALS

10: first housing; 11: first accommodating cavity; 111: first front cavity; 112: first rear cavity; 12: first active vibrating diaphragm; 13: second active vibrating diaphragm; 14: first output port; 20: second housing; 21: second accommodating cavity; 22: first passive vibrating diaphragm; 30: second passive vibrating diaphragm; 31: central magnetic block; 32: magnetic component; 321: first magnetic member; 322: second magnetic member; 33: third housing; 34: third accommodating cavity; 35: surround portion; and 40: extension pipeline.

### DETAILED DESCRIPTION OF THE EMBODIMENTS

The accompanying drawings in the embodiment of the present disclosure are combined, The technical scheme in the embodiment of the present disclosure is clearly and completely described, Obviously, the described embodiment is only a part of the embodiment of the present disclosure, but not all embodiments are based on the embodiment of the present disclosure, and all other embodiments obtained by ordinary technicians in the field on the premise of not doing creative work belong to the protection range of the present disclosure.

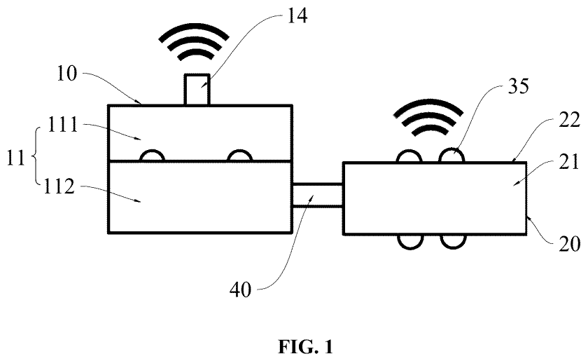

Referring to FIG. 1 to FIG. 15, an embodiment of the present disclosure provides a speaker system and an electronic device that can reduce equivalent rigidity of passive vibrating diaphragms, weaken a low-frequency vibration sensation of the speaker system, and improve low-frequency performance of the speaker system. Referring to FIG. 1, which is a schematic structural diagram of a speaker system according to an embodiment of the present disclosure. The speaker system provided in the present disclosure includes a first housing 10, a second housing 20, and at least one second passive vibrating diaphragm 30.

As an optional implementation, in the present disclosure, a first active vibrating diaphragm 12 is arranged on the first housing 10. The first active vibrating diaphragm 12 can vibrate in a first direction relative to the first housing 10. A first accommodating cavity 11 is arranged inside the first housing 10. A first passive vibrating diaphragm 22 is arranged on the second housing 20. The first passive vibrating diaphragm 22 can vibrate in the first direction relative to the second housing 20. In the present disclosure, the first accommodating cavity 11 is communicated with the second accommodating cavity 21 to form a closed cavity, so that when the first active vibrating diaphragm 12 is driven by electricity to vibrate, the first passive vibrating diaphragm 22 is driven to vibrate in the first direction by affecting an air pressure between the first accommodating cavity 11 and the second accommodating cavity 21.

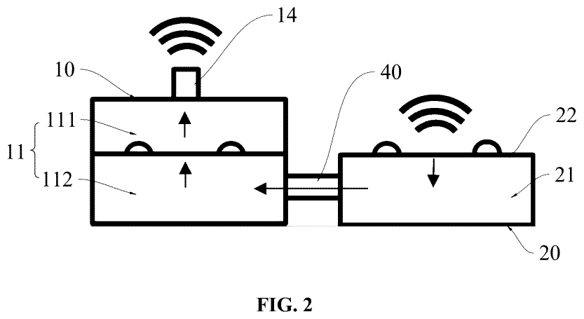

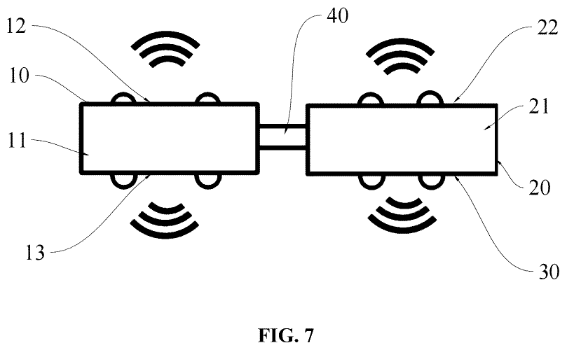

It can be understood that referring to FIG. 2, which is a first schematic structural diagram of a speaker system provided in the conventional technology, the first active vibrating diaphragm 12 can be directly arranged inside the first accommodating cavity 11. As shown in FIG. 7, which is a second schematic structural diagram of a speaker system provided in the conventional technology, the first active vibrating diaphragm 12 can be arranged on the first housing 10. For example, the first active vibrating diaphragm 12 is directly arranged on a side wall of the first housing 10.

Similarly, the first passive vibrating diaphragm 22 can be arranged on an outer side wall of the second housing 20, or can be arranged inside the second accommodating cavity 21. The above arrangement modes for the first passive vibrating diaphragm 22 are feasible. The present disclosure does not impose a further limitation on specific arrangement positions of the first active vibrating diaphragm 12 and the first passive vibrating diaphragm 22.

Further, a vibration starting direction of the first passive vibrating diaphragm 22 and a vibration starting direction of the first active vibrating diaphragm 12 are the same, and a quantity of the second passive vibrating diaphragm 30 is configured to be at least one.

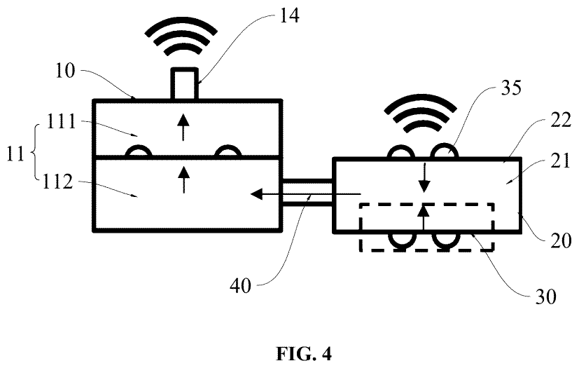

Referring to FIG. 4, which is a diagram of a first embodiment of a speaker system according to an embodiment of the present disclosure, in this application embodiment of the present disclosure, the first passive vibrating diaphragm 22 is arranged on a side wall of the second housing 20, and the second passive vibrating diaphragm 30 is arranged on one side of the second housing 20 facing away from the first passive vibrating diaphragm 22. In this case, both the second passive vibrating diaphragm 30 and the first passive vibrating diaphragm 22 are arranged on an outer side wall of the second housing 20, and a vibration starting direction of the second passive vibrating diaphragm 30 and a vibration starting direction of the first passive vibrating diaphragm 22 are opposite. This can be reflected in FIG. 4 thats directions of surround portions 35 arranged on the first passive vibrating diaphragm 22 and the second passive vibrating diaphragm 30 are opposite.

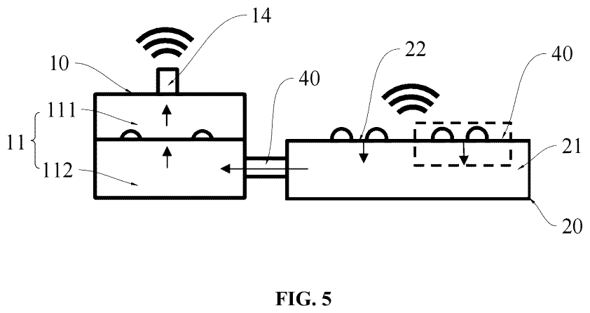

The second passive vibrating diaphragm 30 and the first passive vibrating diaphragm 22 can also be arranged on a side wall of the same side of the second housing 20. Referring to FIG. 5, which is a diagram of a second embodiment of a speaker system according to an embodiment of the present disclosure. Both the first passive vibrating diaphragm 22 and the second passive vibrating diaphragm 30 are arranged on a side wall of the same side of the second housing 20, and a vibration starting direction of the second passive vibrating diaphragm 30 and a vibration starting direction of the first passive vibrating diaphragm 22 are the same. This can be reflected in FIG. 5 that directions of surround portions 35 of the first passive vibrating diaphragm 22 and the second passive vibrating diaphragm 30 are the same.

Certainly, one second passive vibrating diaphragm 30 can also be arranged on the side of the second housing 20 facing away from the first passive vibrating diaphragm 22, to cause the vibration starting direction of the second passive vibrating diaphragm 30 to be opposite to the vibration starting direction of the first passive vibrating diaphragm 22. Meanwhile, another second passive vibrating diaphragm 30 is provided. The second passive vibrating diaphragm 30 and the first passive vibrating diaphragm 22 are arranged on the side wall of the same side of the second housing 20, to cause the vibration starting direction of the second passive vibrating diaphragm 30 to be the same as the vibration starting direction of the passive vibrating diaphragm. By combining the first embodiment and the second embodiment that are shown in FIG. 4 and FIG. 5, the problem of a strong low-frequency vibration sensation caused by a large displacement of a speaker under the same sound pressure level requirement can also be avoided.

It can be understood that it is all feasible that the second passive vibrating diaphragm 30 is arranged on the side of the second housing 20 facing away from the first passive vibrating diaphragm 22, the second passive vibrating diaphragm 30 and the first passive vibrating diaphragm 22 are arranged on the same side of the second housing 20, and the second passive vibrating diaphragms 30 are arranged on the side of the second housing 20 facing away from the first passive vibrating diaphragm 22 and the side of the second housing 20 provided with the first passive vibrating diaphragm 22. In principle, the vibration starting direction of the second passive vibrating diaphragm 30 is correspondingly adjusted according to different arrangement positions. A person skilled in the art should aware of this.

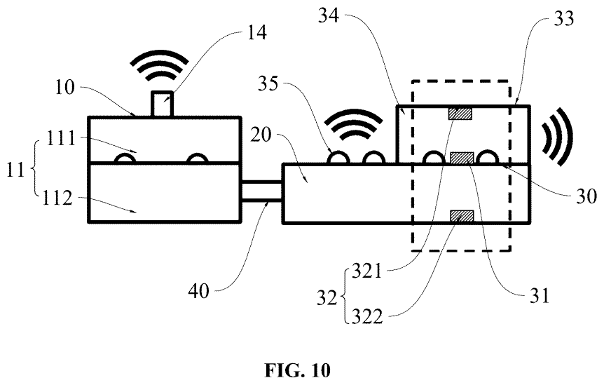

As an optional implementation, in order to make the second passive vibrating diaphragm 30 exhibit a characteristic of a negative rigidity vibrating diaphragm, referring to FIG. 10, which is a schematic structural diagram of a third housing 33 in a speaker system according to an embodiment of the present disclosure. The present disclosure further includes a third housing 33 communicated with the second housing 20, and a third accommodating cavity 34 is arranged inside the third housing 33. Since the second passive vibrating diaphragm 30 is arranged between the second housing 20 and the third housing 33, the second accommodating cavity 21 is separated from the third accommodating cavity 34.

Further, in the present disclosure, a central magnetic block 31 is arranged on the second passive vibrating diaphragm 30, and magnetic components 32 that interact with the central magnetic block 31 are arranged inside the second accommodating cavity 21 and the third accommodating cavity 34. Preferably, the central magnetic block 31 is fixed on one side of the second passive vibrating diaphragm 30 close to the third accommodating cavity 34.

Specifically, the magnetic components 32 include a first magnetic member 321 arranged on an inner side wall of the third accommodating cavity 34 and a second magnetic member 322 arranged on an inner side wall of the second accommodating cavity 21. Preferably, the first magnetic member 321 is arranged on an inner side wall of one side of the third accommodating cavity 34 away from the central magnetic block 31, and the second magnetic member 322 is arranged on an inner side wall of one the second accommodating cavity 21 away from the central magnetic block 31. By controlling magnetization directions of the magnetic components 32 and a magnetization direction of the central magnetic block 31, vibrations of the second passive vibrating diaphragm 30 in the first direction between the second accommodating cavity 21 and the third accommodating cavity 34 are correspondingly controlled.

In an optional embodiment, in the present disclosure, magnetization directions of the first magnetic member 321, the second magnetic member 322, and the central magnetic block 31 are the same, so that a resultant force exerted to the central magnetic block 31 by the first magnetic member 321 and the second magnetic member 322 when the second passive vibrating diaphragm 30 is in a non-vibrating state is zero.

In this embodiment of the present disclosure, when the second passive vibrating diaphragm 30 is in a stationary state, the resultant force exerted to the second passive vibrating diaphragm 30 by the first magnetic member 321 and the second magnetic member 322 that are located on two opposite sides is zero. Since the magnetization direction of the central magnetic block 31 is the same as the magnetization directions of the first magnetic member 321 and the second magnetic member 322, it can also be understood that when the second passive vibrating diaphragm 30 is in the stationary state, a resultant force of magnetic attraction forces exerted, to the central magnetic block 31 arranged on the second passive vibrating diaphragm 30, by the first magnetic member 321 and the second magnetic member 322 that are located on the two opposite sides is zero.

Since the first accommodating cavity 11 and the second accommodating cavity 21 are communicated with each other to form the closed cavity, when the first active vibrating diaphragm 12 is driven by electricity to vibrate in the first direction within the first accommodating cavity 11, an internal air pressure of the second accommodating cavity 21 may be affected. When the second passive vibrating diaphragm 30 and the first passive vibrating diaphragm 22 are arranged on the same side of the second housing 20, fluctuations of the internal air pressure may break a balanced state of the first passive vibrating diaphragm 22 and the second passive vibrating diaphragm 30.

Further, the first passive vibrating diaphragm 22 and the second passive vibrating diaphragm 30 can vibrate in the first direction within the second accommodating cavity 21 under the impact of the fluctuations of the internal air pressure. When the second passive vibrating diaphragm 30 vibrates in the first direction, the resultant force exerted to the second passive vibrating diaphragm 30 by the first magnetic member 321 and the second magnetic member 322 changes. In addition, the magnetization directions of the first magnetic member 321 and the second magnetic member 322 are the same as the magnetization direction of the central magnetic block 31. Therefore, the central magnetic block 31 receives attraction forces of the first magnetic member 321 and the second magnetic member 322, and a restoring force of the second passive vibrating diaphragm 30 during the vibration in the first direction will be reduced.

In this embodiment of the present disclosure, since the magnetization directions of the magnetic components 32 are the same as the magnetization direction of the central magnetic block 31, a magnetic attraction force will be generated between the central magnetic block 31 and the first magnetic member 321 arranged in the third accommodating cavity 34, as well as the second magnetic member 322 arranged in the second accommodating cavity 21. The magnetic attraction force can reduce the restoring force of the second passive vibrating diaphragm 30 during the vibration in the first direction, to cause the second passive vibrating diaphragm 30 to exhibit a characteristic of a negative rigidity vibrating diaphragm. The present disclosure provides negative rigidity to the speaker system through the second passive vibrating diaphragm 30, so that without increasing the mass of the first passive vibrating diaphragm 22 and without putting forward a requirement for the rigidity of the first passive vibrating diaphragm 22, low-frequency sound absorption is implemented at an extremely small depth of the second accommodating cavity 21, a low-frequency vibration sensation of the speaker system is weakened, and a size requirement of the speaker system is lowered.

It can be understood that negative rigidity means a phenomenon that the deformation of an object decreases with an increase in an external force under the action of the external force. Under normal circumstances, the deformation of the object increases with the increase in the external force, while the negative rigidity is an opposite phenomenon. That is, the deformation of the object decreases with the increase in the external force. In this embodiment of the present disclosure, by setting the magnetization directions of the magnetic components 32 to be the same as the magnetization direction of the central magnetic block 31, the magnetic attraction forces generated by the magnetic components 32 on the central magnetic block 31 can reduce the restoring force of the second passive vibrating diaphragm 30 during the vibration in the first direction, so that the second passive vibrating diaphragm 30 exhibits the characteristic of the negative rigidity vibrating diaphragm, thereby providing the negative rigidity to the speaker system.

As an optional implementation, the first magnetic member 321, the central magnetic block 31, and the second magnetic member 322 are preferably arranged in the first direction. Each of the first magnetic member 321 and the second magnetic member 322 includes at least one magnetic block. When each of the first magnetic member 321 and the second magnetic member 322 includes only one magnetic block, it should be ensured that projections of the first magnetic member 321 and the second magnetic member 322 in the first direction at least partially overlap a projection of the central magnetic block 31 in the first direction, thereby ensuring a magnetic attraction force effect formed between the first magnetic member 321, as well as the second magnetic member 322, and the central magnetic block 31.

Certainly, a specific quantity of magnetic blocks arranged in the first magnetic member 321 and the second magnetic member 322 can also be adjusted according to an actual need. In principle, as long as the second passive vibrating diaphragm 30 is not required to vibrate, another setting form in which the resultant force of the magnetic attraction forces exerted to the central magnetic block 31 by the first magnetic member 321 and the second magnetic member 322 that are located on the two opposite sides is also feasible. The present disclosure does not impose a further limitation on this.

Further, continuing to refer to FIG. 4 and FIG. 5, the first accommodating cavity 11 and the second accommodating cavity 21 can be communicated through at least one extension pipe 40. In this case, a closed cavity can be formed among the first accommodating cavity 11, the extension pipe 40, and the second accommodating cavity 21. When the first active vibrating diaphragm 12 is driven by electricity to vibrate in the first direction relative to the first housing 10, an internal air pressure among the first accommodating cavity 11, the extension pipe 40, and the second accommodating cavity 21 can be affected. Fluctuations of the internal air pressure can cause the first passive vibrating diaphragm 22 to vibrate in the first direction relative to the second housing 20. The present disclosure balances forces generated by the vibrations of the vibrating diaphragms in the speaker system by reducing a restoring force of the second passive vibrating diaphragm 30 during the vibration in the first direction, thereby insignificantly reducing a vibration sensation of the speaker system.

In an optional embodiment, continuing to refer to FIG. 4, when the first active vibrating diaphragm 12 is arranged inside the first accommodating cavity 11, the first active vibrating diaphragm 12 can divide the first accommodating cavity 11 into a first front cavity 111 and a first rear cavity 112. In this case, the first rear cavity 112 is communicated with the second accommodating cavity 21 to form the desired closed cavity.

Similarly, at least one extension pipe 40 can be arranged between the first rear cavity 112 and the second accommodating cavity 21. The first rear cavity 112 and the second accommodating cavity 21 are communicated through the at least one extension pipe 40 to form the desired closed cavity. When the first active vibrating diaphragm 12 is driven by electricity to vibrate in the first direction within the first accommodating cavity 11, an internal air pressure among the first rear cavity 112, the extension pipe 40, and the second accommodating cavity 21 can be affected, and then the first passive vibrating diaphragm 22 and the second passive vibrating diaphragm 30 to vibrate in the first direction relative to the second housing 20. The present disclosure does not excessively elaborate a specific process of how to drive the first passive vibrating diaphragm 22 and the second passive vibrating diaphragm 30 to vibrate in the first direction.

As a further improvement of the present disclosure, continuing to refer to FIG. 4 and FIG. 5, when the first active vibrating diaphragm 12 is arranged inside the first accommodating cavity 11, the first housing 10 is further provided with a first output port 14 for communicating the first front cavity 111 to the outside, so that the speaker system radiates a generated low-frequency sound to the outside of the first housing 10 through the first output port 14, so that the speaker system radiates a required audio frequency to the outside, to meet a multilevel resonance requirement of the speaker system.

In an optional embodiment, referring to FIG. 7, a second active vibrating diaphragm 13 can also be arranged on the first housing 10. In this case, both the first active vibrating diaphragm 12 and the second active vibrating diaphragm 13 are arranged on a side wall of the first housing 10. The second active vibrating diaphragm 13 is arranged on one side of the first housing 10 facing away from the first active vibrating diaphragm 12, and a vibration starting direction of the first active vibrating diaphragm 12 and a vibration starting direction of the second active vibrating diaphragm 13 are opposite. That is, directions of surround portions 35 of the first active vibrating diaphragm 12 and the second active vibrating diaphragm 13 are opposite.

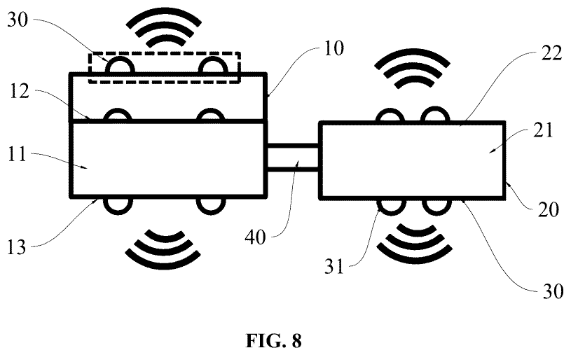

On the basis of the first active vibrating diaphragm 12 and second active vibrating diaphragm 13, at least two second passive vibrating diaphragms 30 need to be provided. Referring to FIG. 8, which is a diagram of a third embodiment of a speaker system according to an embodiment of the present disclosure, one second passive vibrating diaphragm 30 can be arranged on one side of the second housing 20 facing away from the first passive vibrating diaphragm 22, to make a vibration starting direction of the second passive vibrating diaphragm 30 the same as a vibration starting direction of the first passive vibrating diaphragm 22. The other second passive vibrating diaphragm 30 can be arranged on one side of the first housing 10 facing away from the second active vibrating diaphragm 13, to make a vibration starting direction of the other second passive vibrating diaphragm 30 the same as the vibration starting direction of the first passive vibrating diaphragm 22.

In this embodiment of the present disclosure, the second passive vibrating diaphragm 30 is arranged on the side of the second housing 20 facing away from the first passive vibrating diaphragm 22, and the vibration starting direction of the second passive vibrating diaphragm 30 and the vibration starting direction of the first passive vibrating diaphragm 22 are opposite. By reducing a restoring force of the second passive vibrating diaphragm 30 during vibration in the first direction, forces generated in the speaker system due to the vibration of the second passive vibrating diaphragm 30 are balanced, a vibration sensation of the speaker system is greatly reduced, and a low-frequency vibration sensation is weakened.

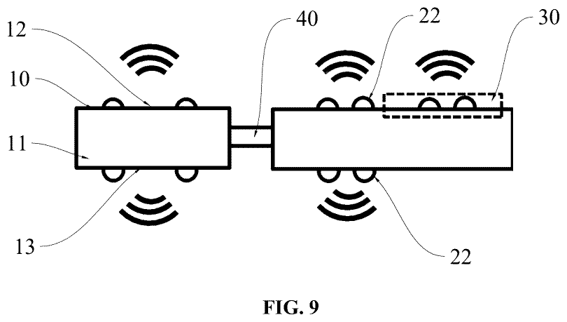

Referring to FIG. 9, which is a diagram of a fourth embodiment of a speaker system according to an embodiment of the present disclosure, one second passive vibrating diaphragm 30 can be arranged on one side of the second housing 20 facing away from the first passive vibrating diaphragm 22, to make a vibration starting direction of the second passive vibrating diaphragm 30 the same as a vibration starting direction of the first passive vibrating diaphragm 22. The other second passive vibrating diaphragm 30 and the first passive vibrating diaphragm 22 can be arranged on the same side of the second housing 20, to make a vibration starting direction of the second passive vibrating diaphragm 30 the same as the vibration starting direction of the first passive vibrating diaphragm 22.

Certainly, corresponding second passive vibrating diaphragms 30 can be arranged on the side of the second housing 20 facing away from the first passive vibrating diaphragm 22, on the side of the second housing 20 provided with the first passive vibrating diaphragm 22, and on the side of the first housing 10 facing away from the second active vibrating diaphragm 13. Specific vibration starting directions of the second passive vibrating diaphragms 30 are defined according to actual application needs and application scenarios, to significantly improve a low-frequency sound pressure level (SPL) of the speaker system and weaken a low-frequency vibration sensation.

It should be noted that continuing to refer to FIG. 8, when the other second passive vibrating diaphragm 30 is arranged on the side of the first housing 10 facing away from the second active vibrating diaphragm 13, a gap for allowing the first active vibrating diaphragm 12 to vibrate in the first direction needs to be provided between the second passive vibrating diaphragm 30 and the first active vibrating diaphragm 12, to avoid the impact of a short distance between the first active vibrating diaphragm 12 and the second passive vibrating diaphragm 30 on normal vibration of the first active vibrating diaphragm 12 in the first direction.

It can be understood that although the above embodiments only show the arrangement mode for one first housing 10 and one second housing 20, arranging a plurality of first housings 10 and a plurality of second housings 20 communicated with the first housings 10 to implement a desired low-frequency vibration sensation is a simple principle extension in the art. On the premise that the costs and volume of the speaker system are desirable, quantities and specific arrangement positions of the first housing 10, the second housing 20, the first active vibrating diaphragm 12, the second active vibrating diaphragm 13, the first passive vibrating diaphragm 22, and the second passive vibrating diaphragm 30 can be adaptively adjusted to make the speaker system provided in the present disclosure easier to be debugged to a desired frequency. The present disclosure does not impose a further limitation on this.

In the present disclosure, the restoring force of the second passive vibrating diaphragm 30 during the vibration in the first direction is reduced by arranging the magnetic components 32 and the central magnetic block 31, thereby correspondingly adjusting the resultant force of the speaker system and making the resultant force of the speaker system maintain a weak vibration sensation in both a low frequency band and a middle to high frequency band.

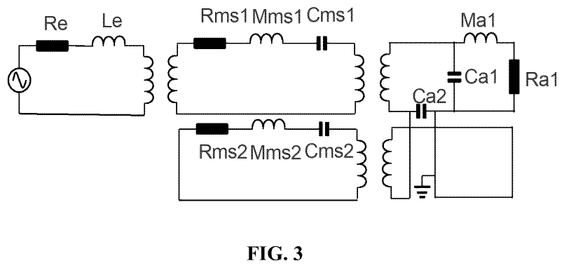

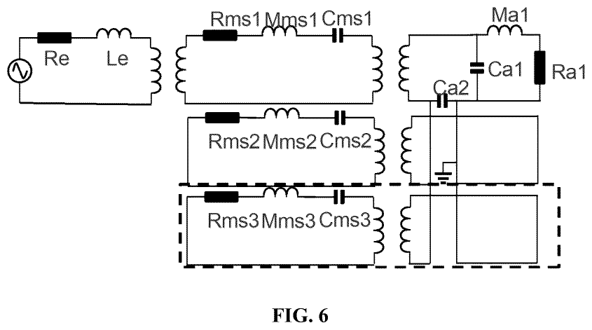

As an optional implementation, referring to FIG. 3, which is an equivalent circuit diagram of the speaker system shown in FIG. 2, and FIG. 6, which is an equivalent circuit diagram of the speaker system shown in FIG. 1, it can be observed that the speaker system provided in the present disclosure causes the second passive vibrating diaphragm 30 to exhibit the characteristic of the negative rigidity vibrating diaphragm. Under a requirement for the same frequency design as the conventional speaker system, the mass of the first passive vibrating diaphragm 22 can be effectively reduced, and the low-frequency vibration sensation can be effectively weakened.

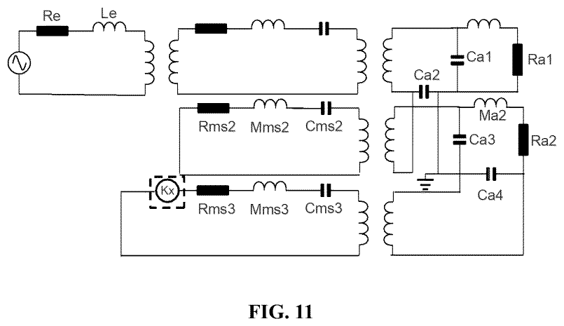

Referring to FIG. 11, which is an equivalent circuit diagram of the speaker system shown in FIG. 8 or FIG. 9, it can be observed that the speaker system provided in the present disclosure is equivalent to adding an equivalent negative rigidity voltage source Kx to the structure of the conventional speaker system. Therefore, the negative rigidity of the second passive vibrating diaphragm 30 can be adjusted through this equivalent negative rigidity voltage source KX, so that the speaker system radiates a required audio frequency to the outside, to meet a multilevel resonance requirement of the speaker system.

It can be understood that in FIG. 3, FIG. 6, and FIG. 11, Re represents a direct-current resistance of a voice coil; Le represents a voice coil inductance; Ma represents an equivalent acoustic mass of a tube cavity structure; Ca represents an equivalent acoustic capacitance of the tube cavity structure; and Ra represents an equivalent acoustic resistance of the tube cavity structure. The tube cavity structure in FIG. 3 and FIG. 6 is formed by communicating first rear cavity 112, the extension pipeline 40, and the second accommodating cavity 21, while the tube cavity structure in FIG. 11 is formed by the first accommodating cavity 11, the extension pipeline 40, and the second accommodating cavity. A person skilled in the art should be aware of this.

Specifically, continuing to refer to FIG. 6, FIG. 10, and FIG. 11, a force on the first active vibrating diaphragm 12 is F₁; a force on the first passive vibrating diaphragm 22 is F₂; a force on the second passive vibrating diaphragm 30 is F₃; and calculation formulas of F₁, F₂, and F₃ are as follows:

$$\{ \begin{matrix}{F}_{1} = {u}_{1} * ω * {Mms}_{1} \\ {F}_{2} = \frac{{u}_{1} * ω * S {d}_{1} * Z a}{Z {a}_{2} * S {d}_{2}} {Mms}_{2} \\ {F}_{3} = \frac{{u}_{1} * ω * S {d}_{1} * Z a}{Z {a}_{3} * S {d}_{3}} {Mms}_{3}\end{matrix}$$

where u₁ represents a vibration speed of the first active vibrating diaphragm 12.

Further, a calculation formula of an equivalent acoustic impedance Za of the speaker system is as follows:

$$\{ \begin{matrix}Z c {a}_{2} = \frac{1}{j ω {Ca}_{2}} \\ Z {a}_{2} = \frac{R m {s}_{2} + j ω {Mms}_{2} + \frac{1}{j ω {Cms}_{2}}}{S {d}_{2}^{2}} \\ Z {a}_{3} = \frac{R m {s}_{3} + j ω {Mms}_{3} + \frac{1}{j ω {Cms}_{3}}}{S {d}_{3}^{2}}\end{matrix} ;$$

$$Za = \frac{1}{\frac{1}{{Zca}_{2}} + \frac{1}{{Za}_{2}} + \frac{1}{{Za}_{3}}} .$$

It can be seen that on the premise that parameters of the first active vibrating diaphragm 12 and the first passive vibrating diaphragm 22 are given, by adjusting parameters and a vibration starting direction of the added second passive vibrating diaphragm 30 within a proper range, an overall force on the speaker system can be adjusted, thereby weakening the low-frequency vibration sensation of the speaker system according to a need.

Specifically, Mms represents an equivalent vibration mass of a vibrating diaphragm; Cms represents an equivalent compliance of the vibrating diaphragm; Rms represents a resistance to the vibrating diaphragm during vibration; and Sd represents an effective area of the vibrating diaphragm. The parameter, i.e. the equivalent vibration mass Mms, is used as an example; Mms1 corresponds to an equivalent vibration mass of the first active vibrating diaphragm 12; Mms2 corresponds to an equivalent vibration mass of the first passive vibrating diaphragm 22; and Mms3 corresponds to an equivalent vibration mass of the second passive vibrating diaphragm 30. The present disclosure will not elaborate other parameters of the vibrating diaphragms here.

Referring to FIG. 11, the parameters Mms, Cms, and Rms of the second passive vibrating diaphragm 30 respectively correspond to Mms3, Cms3, and Rms3 in FIG. 11. Mms3 represents an equivalent vibration mass of the second passive vibrating diaphragm 30; Cms3 represents an equivalent compliance of the second passive vibrating diaphragm 30; Rms3 represents a resistance to the second passive vibrating diaphragm 30 during vibration; and Sd3 represents an effective area of the second passive vibrating diaphragm 30. By adjusting the above parameters, the equivalent acoustic impedance Za of the speaker system can be adjusted correspondingly.

In this embodiment of the present disclosure, when the second passive vibrating diaphragm 30 is in an initial balance position, upward and downward magnetic attraction forces exerted to the second passive vibrating diaphragm 30 by the first magnetic member 321 and the second magnetic member 322 are equal, and a total magnetic attraction force F is 0. When the first active vibrating diaphragm 12 is driven by electricity to vibrate, internal pressures of the first housing 10 and the second housing 20 change, thus breaking the balance state of the second passive vibrating diaphragm 30 and generating vibration.

Specifically, when the second passive vibrating diaphragm 30 vibrates upwards, the upward magnetic attraction force exerted to the second passive vibrating diaphragm 30 by the first magnetic member 321 increases, and a downward magnetic attraction force exerted to the second passive vibrating diaphragm 30 by the second magnetic member 322 decreases, so that the total magnetic attraction force F is upward. This total magnetic attraction force F is opposite to the restoring force (Kms3*−dis) of the second passive vibrating diaphragm 30 itself. When the second passive vibrating diaphragm 30 vibrates downwards, the downward magnetic attraction force exerted to the second passive vibrating diaphragm 30 by the second magnetic member 322 increases, and the upward magnetic attraction force exerted to the second passive vibrating diaphragm 30 by the first magnetic member 321 decreases, so that the total magnetic attraction force F is downward. This total magnetic attraction force F is also opposite to the restoring force (Kms3*−dis) of the second passive vibrating diaphragm 30 itself. Therefore, equivalent mechanical rigidity exhibited by the second passive vibrating diaphragm 30 is K=(Kms3*−dis+F)/−dis.

When the central magnetic block 31 and the magnetic components 32 are not added, an equivalent mechanical rigidity exhibited by the second passive vibrating diaphragm 30 is Kori=(Kms3*−dis)/−dis. It is apparent K<Kori. Therefore, after the addition of the central magnetic block 31 and the magnetic components 32, the second passive vibrating diaphragm 30 exhibits a negative rigidity characteristic, where Kms3=1/Cms3 and dis represents a displacement of the second passive vibrating diaphragm 30 in the first direction.

It can be understood that the total magnetic attraction force F generated by the central magnetic block 31 and the magnetic components 32 in a case that the displacement of the second passive vibrating diaphragm 30 changes can be characterized by multiplying rigidity Kx and displacement dis under a displacement change. Meanwhile, the total magnetic attraction F is always opposite to the restoring force (Kms3*−dis) of the second passive vibrating diaphragm 30 itself in a non-balance position. Therefore, this negative rigidity unit can be equivalent to a negative rigidity element in a circuit diagram. Through an optimized design, it can present a linear relationship. Specifically, this negative rigidity element is represented as the voltage source Kx in FIG. 11.

Continuing to refer to FIG. 2 and FIG. 3, by observing the speaker system provided in conventional technology and its corresponding equivalent circuit diagram, it can be seen that in the conventional speaker system, due to a difference between a resonance frequency of the first active vibrating diaphragm 12 and a resonance frequency of the first passive vibrating diaphragm 22, displacements generated by the first active vibrating diaphragm 12 and the first passive vibrating diaphragm 22 in a low frequency band are in opposite directions, and displacements generated in a middle to high frequency band are in the same direction. A resultant force generated by the entire speaker system will form a maximum value at a middle to high frequency position. In this case, the vibration sensation is strongest. If the first passive vibrating diaphragm 22 is mounted on a lower wall surface of the second housing 20, since the first passive vibrating diaphragm 22 generates a large displacement in the low frequency band and generates a small displacement in the middle to high frequency band, the speaker system can form a strong vibration sensation in the low frequency band. Therefore, the speaker system provided in conventional technology cannot maintain a weak vibration sensation within operating frequency bands, such as both the low frequency band and the middle to high frequency band.

In this embodiment of the present disclosure, by the arrangement of the second passive vibrating diaphragm 30 that is arranged on the same side as the first passive vibrating diaphragm 22 and has the same vibration starting direction as the first passive vibrating diaphragm 22, and/or by the arrangement of the second passive vibrating diaphragm 30 that is arranged on the side different from the side with the first passive vibrating diaphragm 22 and has the vibration starting direction opposite to the vibration starting direction of the first passive vibrating diaphragm 22, it is possible to adjust the resultant force of the speaker system to maintain a weak vibration sensation in both the low frequency band and the middle to high frequency band. Specifically, the force F3 generated by the second passive vibrating diaphragm 30 can be adjusted by adjusting the equivalent parameters Mms, Cms, Rms, and Sd of the second passive vibrating diaphragm 30, and then the overall force of the speaker system can be adjusted based on F3 to weaken the low-frequency vibration sensation of the speaker system. The present disclosure will not elaborate specific steps and principles of how to perform the adjustment.

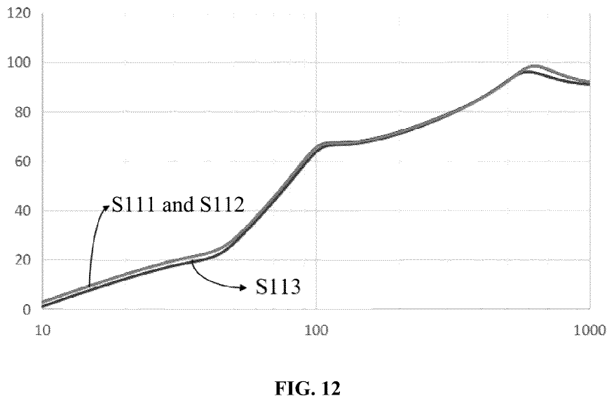

Referring to FIG. 12, which is a comparison diagram of a sound pressure level curve of the speaker system shown in FIG. 8 and FIG. 9 and a sound pressure level curve of the speaker system shown in FIG. 7. In FIG. 12, a horizontal axis represents a frequency in unit of Hz, and a vertical axis represents a sound pressure value in unit of dB. The curves of S111 and S112 in FIG. 12 are frequency response curves of the speaker system shown in FIG. 8, and the curve of S113 in FIG. 12 is a frequency response curve of the speaker system shown in FIG. 9. Through comparison, it can be clearly observed that when the speaker system provided in the present disclosure is configured as the speaker system shown in FIG. 9, a resonance frequency implemented is lower and a low-frequency sensitivity is better.

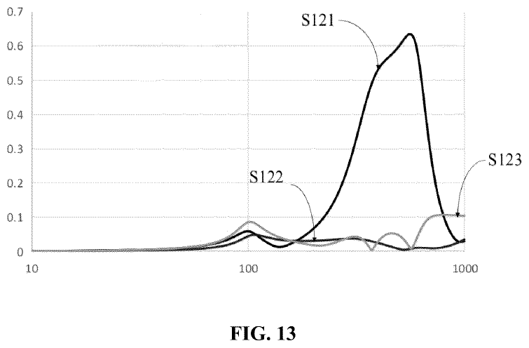

Referring to FIG. 13, which is a comparison diagram of a curve of a resultant force on the speaker system shown in FIG. 8 and FIG. 9 and a curve of a resultant force on the speaker system shown in FIG. 7. In FIG. 13, a horizontal axis represents a frequency in unit of Hz, and a vertical axis represents a resultant force in unit of N of the speaker system in the first direction. The curve of S121 in FIG. 13 represents the resultant force of the speaker system shown in FIG. 7 in the first direction; the curve of S122 in FIG. 13 represents the resultant force of the speaker system shown in FIG. 8 in the first direction; and the curve of S123 in FIG. 13 represents the resultant force of the speaker system shown in FIG. 9 in the first direction. Through comparison, it can be observed that arranging the second passive vibrating diaphragm 30 can reduce the resultant force of the speaker system in the first direction and reduce the restoring force of the second passive vibrating diaphragm 30 during vibration in the first direction, thereby effectively improving low-frequency performance of the speaker system.

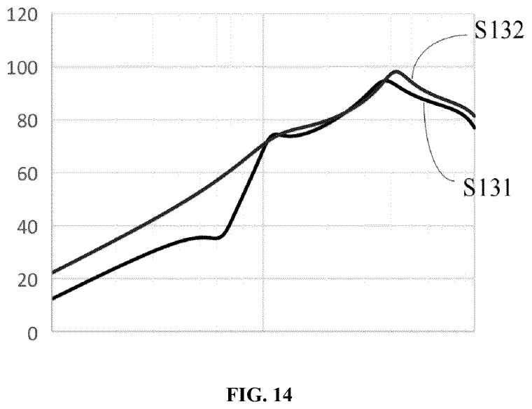

Further, referring to FIG. 14, which is a comparison diagram of a sound pressure level curve of the speaker system shown in FIG. 10 and a sound pressure level curve of the speaker system shown in FIG. 7. In FIG. 14, a horizontal axis represents a frequency in unit of Hz, and a vertical axis represents a sound pressure value in unit of dB. The curve S131 in FIG. 14 represents a frequency response curve of the speaker system provided in the conventional technology; and the curve S132 in FIG. 14 represents a frequency response curve of the speaker system provided in the present disclosure (as shown in FIG. 10). Through comparison, it can be clearly observed that the speaker system provided in the present disclosure significantly improves a low-frequency SPL and weakens a low-frequency vibration sensation while maintaining the same low-frequency resonance frequency.

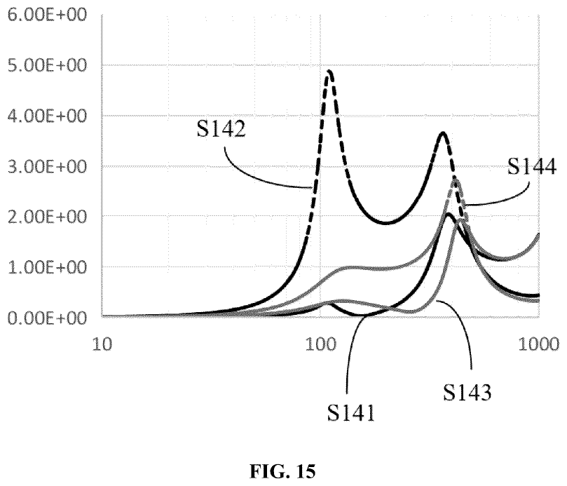

Referring to FIG. 15, which is a comparison diagram of forces changing with frequencies of first active vibrating diaphragms 12 and first passive vibrating diaphragms 22 in the speaker system shown in FIG. 10 and the speaker system shown in FIG. 7. In FIG. 15, a horizontal axis represents a frequency in unit of Hz, and a vertical axis represents a force in unit of N on the first active vibrating diaphragm 12 and a force in unit of N on the first passive vibrating diaphragm 22. The curves S141 and S142 in FIG. 15 are curves in which the force on the first active vibrating diaphragm 12 and the force on the first passive vibrating diaphragm 22 change with the frequency in the conventional technology. The curves S143 and S144 in FIG. 15 are curves in which the force on the first active vibrating diaphragm 12 and the force on the first passive vibrating diaphragm 22 in the speaker system provided in the present disclosure (as shown in FIG. 10) change with the frequency. Through comparison, it can be clearly observed that the displacements of the first active vibrating diaphragm 12 and the first passive vibrating diaphragm 22 in the speaker system provided by the present disclosure are smaller at a low frequency, thus requiring a smaller overall size of the speaker system and effectively meeting a design requirement of a micro speaker.

Based on the above speaker system, the present disclosure further provides an electronic device. The electronic device can be a mobile phone, a tablet computer, a speaker box, and the like. The above speaker system is applied to the electronic device. A controller for driving the first active vibrating diaphragm to vibrate can be arranged in the electronic device to indirectly drive the first passive vibrating diaphragm to vibrate. For other details of the electronic device for implementing the above technical solutions, refer to the description of the speaker system provided in the above embodiments of the present disclosure, which will not be elaborated here.

It should be finally noted that the various above embodiments are only used to describe the technical solutions of the present disclosure, and not intended to limit the present disclosure. Although the present disclosure has been described in detail with reference to the foregoing embodiments, those ordinarily skilled in the art should understand that they can still modify the technical solutions described in all the foregoing embodiments, or equivalently replace some or all of the technical features, and these modifications or replacements do not depart the essences of the corresponding technical solutions from the spirit and scope of the technical solutions of all the embodiments of the present disclosure.

What is claimed is:

1. A speaker system, comprising:
a first housing, wherein a first accommodating cavity is arranged inside the first housing;
a first active vibrating diaphragm, wherein the first active vibrating diaphragm is arranged inside the first accommodating cavity;
a second housing, wherein a second accommodating cavity is arranged inside the second housing, and the second accommodating cavity is communicated with the first accommodating cavity to form a closed cavity;
a first passive vibrating diaphragm, wherein the first passive vibrating diaphragm is arranged on one side of the second housing and is driven by the first active vibrating diaphragm to vibrate; and
at least one second passive vibrating diaphragm, wherein the second passive vibrating diaphragm is arranged on one side of the second housing facing away from the first passive vibrating diaphragm, and a vibration starting direction of the second passive vibrating diaphragm and a vibration starting direction of the first passive vibrating diaphragm are opposite; and/or, the second passive vibrating diaphragm and the first passive vibrating diaphragm are arranged on the same side of the second housing, and a vibration starting direction of the second passive vibrating diaphragm and a vibration starting direction of the first passive vibrating diaphragm are the same.

2. The speaker system according to claim 1,
further comprising a third housing communicated with the second housing, wherein a third accommodating cavity is arranged inside the third housing; the second passive vibrating diaphragm is arranged between the second housing and the third housing, to separate the second accommodating cavity from the third accommodating cavity; a central magnetic block is arranged on the second passive vibrating diaphragm; and magnetic components that interact with the central magnetic block are arranged inside the second accommodating cavity and the third accommodating cavity.

3. The speaker system according to claim 2, wherein
the magnetic components comprise a first magnetic member arranged on an inner wall of the third accommodating cavity and a second magnetic member arranged on an inner wall of the second accommodating cavity; the central magnetic block is fixedly arranged on one side of the second passive vibrating diaphragm close to the third accommodating cavity; and
magnetization directions of the first magnetic member, the second magnetic member, and the central magnetic block are the same, so that a resultant force exerted to the central magnetic block by the first magnetic member and the second magnetic member when the second passive vibrating diaphragm is in a non-vibrating state is zero.

4. The speaker system according to claim 1, wherein
the second accommodating cavity is communicated with the first accommodating cavity through at least one extension pipeline to form the closed cavity.

5. The speaker system according to claim 1, wherein
the first active vibrating diaphragm is arranged inside the first accommodating cavity to divide the first accommodating cavity into a first front cavity and a first rear cavity; and the first rear cavity is communicated with the second accommodating cavity to form the closed cavity.

6. The speaker system according to claim 5, wherein
the first housing is provided with a first output port for communicating the first front cavity with the outside, and the speaker system radiates a sound to the outside of the first housing through the first output port.

7. The speaker system according to claim 5, wherein
the first rear cavity is communicated with the second accommodating cavity through at least one extension pipeline to form the closed cavity.

8. The speaker system according to claim 1, wherein
the vibration starting direction of the first passive vibrating diaphragm and a vibration starting direction of the first active vibrating diaphragm are the same.

9. The speaker system according to claim 1, wherein
the first housing is further provided with a second active vibrating diaphragm; the second active vibrating diaphragm is arranged on one side of the first housing facing away from the first active vibrating diaphragm; and a vibration starting direction of the second active vibrating diaphragm and a vibration starting direction of the first active vibrating diaphragm are opposite.

10. The speaker system according to claim 9, wherein
a quantity of the second passive vibrating diaphragm is configured to be at least two; one of the second passive vibrating diaphragms is arranged on the side of the second housing facing away from the first passive vibrating diaphragm, and the vibration starting direction of the second passive vibrating diaphragm and the vibration starting direction of the first passive vibrating diaphragm are opposite;
the other second passive vibrating diaphragm is arranged on one side of the first housing facing away from the second active vibrating diaphragm and has the same vibration starting direction as the first passive vibrating diaphragm; and/or, the other second passive vibrating diaphragm and the first passive vibrating diaphragm are arranged on the same side of the second housing, and has the same vibration starting direction as the first passive vibrating diaphragm.

11. The speaker system according to claim 10, wherein
when the other second passive vibrating diaphragm is arranged the side of the first housing facing away from the second active vibrating diaphragm, a gap for allowing the first active vibrating diaphragm to vibrate is provided between the second passive vibrating diaphragm and the first active vibrating diaphragm.

12. An electronic device, wherein
the electronic device comprises the speaker system according to claim 1.
